(19) United States
(12) Patent Application Publication
(10) Pub. No.: US 2009/0095226 A1
(43) Pub. Date: Apr. 16, 2009

(54) AQUARIUM WATER CHANGING AND WATER STABILIZATION SYSTEM

(76) Inventor: Vincent Riemma, Glenmont, NY (US)

Correspondence Address: HOFFMAN WARNICK LLC, 75 STATE STREET, 14TH FLOOR, ALBANY, NY, 12207, US

(21) Appl. No.: 11/871,605

(22) Filed: Oct. 12, 2007

(51) Int. Cl. A01K 63/04

(52) U.S. Cl. 119/245

(57) ABSTRACT

An aquarium water changing and stabilization system consists of an initial tank designed to stabilize and condition water before it is pumped into a subsequent tank that contains live aquatic animals such as fish. This system has a cabinet that is designed to aesthetically enclose, protect and support the components of the aquarium while providing access to the system. Water is introduced into the system from existing hot and cold water plumbing which is connected to this system. Water exits from this system into existing sewerage plumbing which is also connected to this system. Conditioned water from the conditioning tank is pumped to the main fish tank via plumbing from one tank to the other. In case too much water is introduced to either tank, overflow drains in both tanks prevent water from overflowing over the top of either tank. Plumbing check valves and ball valves create safe and easy plumbing.

This application is related in some aspects to application Ser. No. 10/615,577, filed Jul. 8, 2003, and application Ser. No. 11,735,813, filed Apr. 16, 2007, currently pending.

### BRIEF SUMMARY OF THE PRESENT INVENTION

The inventor, who is an aquarium enthusiast, noted that it is difficult to change a substantial amount of water in a medium to large aquarium. For example, not having running water that runs directly into the aquarium system requires one to use pails and hoses that can cause a mess. Also, taking water directly from an exterior source and introducing it into the aquarium can be detrimental to the health of the living organisms in the aquarium. By attaching a second tank to the main aquarium tank through which water can be transferred, water can be conditioned and stabilized in the secondary tank before being introduced into the main aquarium tank. Also, by attaching an overflow and drainage system from both tanks to an existing sewer connection, allows for fast and safe removal of unwanted aquarium water. Redundant check valves and ball valves may be strategically placed to prevent backflow, valve failure backup and easy use.

As with most medium to large aquarium cabinetry, structural integrity and functionality are important so as to provide support and easy accessibility for the total aquarium system. In this present invention, the second water conditioning and stabilization tank may be located above, below or level with the main aquarium tank by changing water from the second water conditioning and stabilization by way of a pump. Plumbing runs behind and below both tanks.

A cabinet may designed that supports the weight of both tanks when full and allows proper access to all working components of the aquarium.

This invention allows aquarium water to be easily stabilized and conditioned before being introduced into the main aquarium tank and allows for water to be easily and quickly drained from the aquarium. All the components of the aquarium may be supported in a modular cabinet unit that provides easy access to all the important components of the aquarium.

### BRIEF DESCRIPTION OF THE DRAWINGS

Other features and objects of the invention will be apparent from the following specification drawings, all of which disclose non-limiting embodiments of the invention. In the drawings:

FIG. 1 is a close up view of the valve for the top tank of the aquarium from a perspective slightly above and to the right of the aquarium.

FIG. 2 is a right side sectional view of the overflow drainage plumbing only for the aquarium.

FIG. 3A is a sectional right side view of the plumbing and pump that lead from the conditioning tank into the main tank that introduces conditioned water into the main fish tank. The splash guard that buffers the water entering into the main fish tank is visible at the very bottom of this figure.

FIG. 3B is a sectional right side view of the plumbing that leads from a submersible pump in the conditioning tank into the main tank that introduces conditioned water into an aperture in a wall of the main fish tank.

FIG. 4 is a sectional front view of the tanks, tank shelves and plumbing in a side-by-side configuration.

FIG. 5 shows a view of the aquarium in a cabinet from a perspective of slightly above and to the left of the front of the aquarium in which the conditioning tank is below the main tank.

FIG. 6 is a sectional front view of all aquarium plumbing only from a perspective slightly above and to the right of the aquarium.

### DESCRIPTION OF THE PREFERRED EMBODIMENTS

The present invention is a saltwater or freshwater mixing tank and aquarium environmental control system which is designed to exchange used water for pre-conditioned and stabilized water and can be used to quickly drain the main fish tank for easy cleaning and refilling. This invention is designed to connect to existing plumbing both drainage and water supply at the location that the aquarium is installed. Secondly, the current invention could utilize a cabinet that provides access to the components of the aquarium and proper support. One embodiment of the present invention is designed as a complete modular unit in which all of the necessary aquarium components are designed and assembled to work together when connected to existing plumbing. The present invention is a pump-driven aquarium water changing and water stabilization system that allows for a variety of tank position setups and aesthetics.

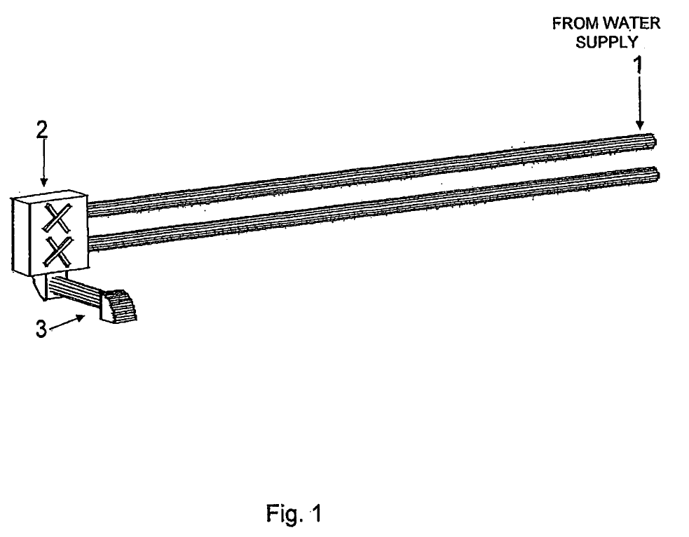

As depicted in FIG. 1 the present invention includes supply lines 1, which may be ½ inch copper, for hot and cold water. A valve body 2, which may be affixed to the cabinet, such as with brackets, mixes hot and cold water, which exits thru the neck of the valve 3.

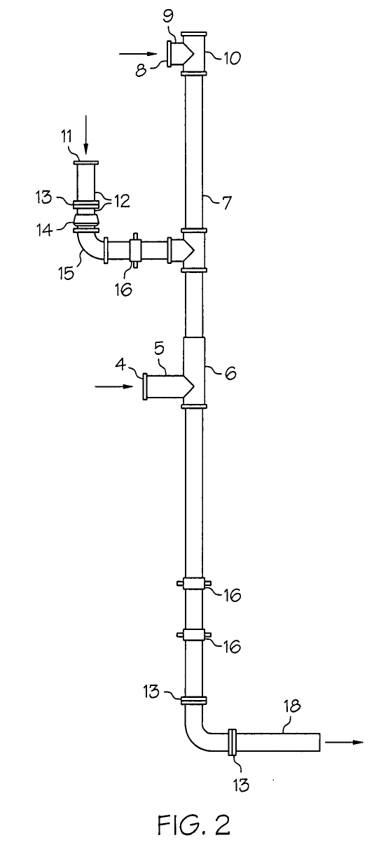

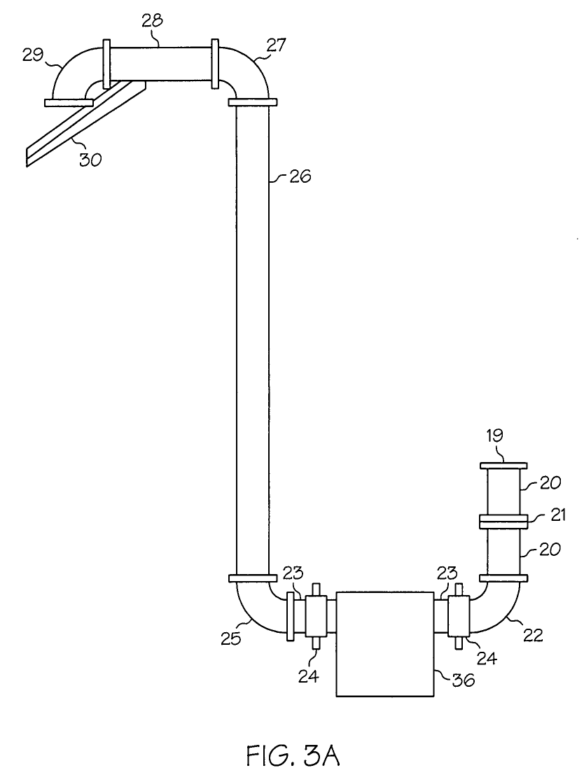

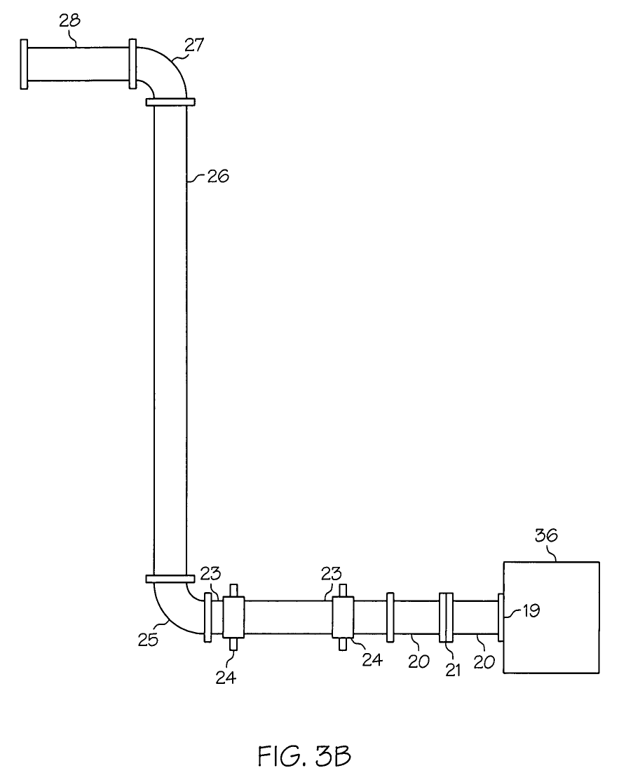

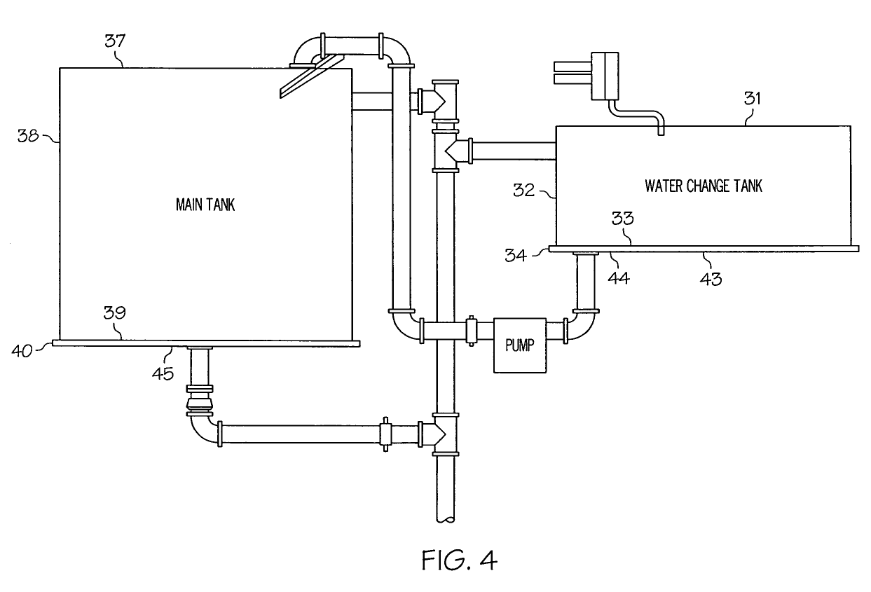

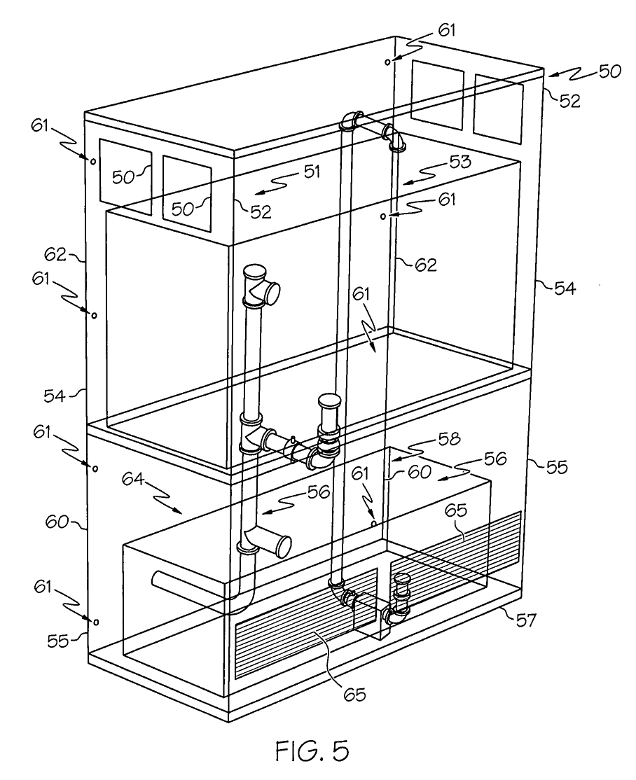

As depicted in FIG. 4 the water change tank 32, can be filled with water that will be pumped into the main fish tank 38, thru piping system (see FIG. 3) that empties from the water change tank 32 (such from an aperture in the bottom or side or through the opening in the top) and exits into the main fish tank 38 (such as through the opening in the top or an aperture in the bottom or side). The use of a pump 36 allows water change tank 32 to be positioned anywhere in relation to main fish tank 38, including above (not illustrated), below (FIG. 5) or on an altitude that is substantially equivalent to that of main fish tank 38 (FIG. 4). In the case of an overfilling of the tanks, an overflow drain piping system, which may be 1.5 inch, (see FIG. 2) allows for proper overflow drainage for both tanks.

As depicted in FIG. 2 the present invention includes an overflow drainage flange 4 that secures a pipe 5, which in one embodiment is a substantially horizontal 1.5 inch pipe, to a wall of the upper part of the water change tank (FIG. 4, 32). In FIG. 2, this pipe empties into a substantially vertical 90.degree. tee connector 6, which connects two substantially vertical segments of pipe 7. A bulkhead fitting 8, which may be 1.5″ diameter and double threaded, is put through a portion of the main fish tank, such as the back of the upper part of the main fish tank (FIG. 4, 38) and is connected to a pipe 9, which may be a horizontal length of 1.5″ diameter pipe which connects to the substantially vertical 90.degree. tee 10. Tee 10 connects to the substantially vertical segment of pipe 7 and serves both as a connector and vent opening for the overflow drain system.

Main fish tank water empties from a drain at the bottom of the main fish tank (FIG. 4, 38). As depicted in FIG. 2, a bulkhead 11, which may be 1.5″ diameter and double threaded, goes through the bottom of the main fish tank and connects to a substantially vertical piece of pipe 12, which, in turn, connects the substantially vertical pipe overflow pipe segment 7 via a 90 degree elbow 15, which may be a 1.5 inch, pointing to the back of the aquarium, a horizontal length and a substantially vertical tee connector. The bottom of the substantially vertical overflow pipe segment 7 connects to a substantially horizontal 90.elbow connector 17. that contains an inner check valve 13, to prevent backflow. A horizontal piece of pipe 18, connects to the back of the elbow connector 17, which is to be connected to existing plumbing. This horizontal drain pipe segment 18 is connected to a vertical primary ball valve 14 that is connected to the elbow 17 and connects to a horizontal secondary ball valve 16, which connects to the front of the horizontal elbow connector 17, at the base of the vertical overflow main pipe 7, although ball valves and check valves may vary in number and positioning according to need. To empty water from the top water change tank (FIG. 4, 32) into the main fish tank (FIG. 4, 38) pipe system, which may be ¾ inch, (see FIG. 3) are used.

While the overflow drainage aspects of the invention have been illustrated with rigid lengths of pipe and connectors, this description and configuration should not be read as limiting. For example, any or all of the pipes described herein may comprise any material now known or later developed for conducting fluids. To this extent, any or all of the pipes described here comprise flexible tubing. Further, the pipes described herein may be oriented in any manner that can be envisioned to affect overflow drainage from the main and water change tanks as well as to provide on-demand drainage. For example, all or a portion of substantially vertical pipe 7 may be oriented along a substantially horizontal axis and may have one or a plurality of substantially vertical pipes feeding into it. Further, multiple drains may provide overflow and/or on-demand drainage from a single tank. Still further, an s-shaped trap or other aspects commonly associated with drainage systems may be incorporated herein.

As depicted in FIG. 3A, a drain flange 19, at the bottom of the water change tank (FIG. 4, 32) connects and secures a substantially vertical pipe segment 20 that contains a check valve 21, to prevent backflow from the lower main fish tank (FIG. 4, 38). In FIG. 3A this substantially vertical pipe segment 20 connects to an elbow 22, and points towards the back of the aquarium, although other configurations are envisioned. The elbow 22 connects to a substantially horizontal pipe segment 23, and a pump 36 with ball valves 34 on either side. This segment connects to an elbow 25, and points upward or downward, depending upon the orientation of the main tank relative to the water change tank, and connects to a substantially vertical nine inch length of pipe 26. At the other end of pipe 26, an elbow 27, is connected pointing towards the interior of the aquarium. This elbow 27, is connected to a length of substantially horizontal pipe 28, which may be 1.5 inch, that goes into the interior of the main fish tank (FIG. 4, 38). In FIG. 3A, pipe 28 connects to an elbow 29 that points downward and allows water to run over a splash guard 30, to buffer the entry of water into the main fish tank (FIG. 4, 38). In the alternative, a length of pipe may extend downward from elbow 29 such that the terminus of the pipe is, preferably, always below the water line of the main tank.

In an alternative embodiment depicted in FIG. 3B, the drain flange 19 or a length of pipe extending from the drain flange on the side of the water change tank (FIG. 4, 32) connects to a submersible pump within water change tank 32 and secures a substantially horizontal pipe segment 20 that contains similar check valves, ball valves and piping as those illustrated in FIG. 3A. In this or either embodiment, pipe 28 may enter directly into the main tank, preferably below the water line, although it is envisioned that entry into the main tank may also be accomplished in the matter illustrated in FIG. 3A or the direct entry method may be incorporated into the inline pump embodiment of FIG. 3A. In the alternative, rather than a drain flange, fluids could be conducted relatively vertically out the top opening of the conditioning tank, eliminating the need to modify the tank, itself.

FIG. 4 is a sectional front view of tanks, and plumbing in the aquarium encased in shelving. The outer cabinet walls, top, bottom and cabinet supports have been hidden in this view to reveal the interior parts of the aquarium. Only the change tank shelf 43, and the main tank shelf 45, are parts of the cabinet. The water change tank 32, has a top tank wall restraint cap, with two equally spaced water access cutouts. The tank wall retainer 31, extends down and around the top of the water change tank 32, such as by one inch, and has a cross piece, which may be two inch, to add strength to the top of the tank. On a wall of the water change tank 32 is the center of a hole 35 that serves as access for the overflow plumbing into the back of the tank and allows excess water to drain out of the tank. The flat bottom of the water change tank 33, and a bottom tank wall retainer 34, may go around the rim of the bottom of the tank raising the tank up off the shelf 43 to prevent condensation on the bottom of the tank. The shelf that the water change tank rests on may have a cutout 44 that allows space for the water change tank 32, transfer line (see FIGS. 3A and 3B) that leads into the main fish tank 38. A circular hole 36 may allow the water change tank transfer line to be connected to the bottom or side of the water change tank via a flange, which may be threaded.

Also, in FIG. 4, the main fish tank 38 rests on a cutout 46 that allows the main fish tank 38, overflow plumbing to go through the shelf 45, and attach to the main fish tank waste line (see FIG. 2). The main fish tank 38 may have a tank wall restraint cap 37, with two equally spaced water access cutouts. The tank wall retainer 37 may extend down and around the top of the main fish tank 38 and may have a cross piece to add strength to the top of the tank. On a wall of the main fish tank 38 is the center of a hole 41, that serves as access for the overflow plumbing into the tank and allows excess water to drain out of the tank, although other locations, lengths and configurations are envisioned. The flat bottom of the main fish tank 39, and a bottom tank wall retainer 40, may go around the rim of the bottom of the tank raising the tank up off the shelf 45 to prevent condensation on the bottom of the tank. In the bottom of the main fish tank 39, there is a circular hole 42 that allows the main fish tank 38, waste line (see FIG. 2) to enter into the bottom of the main fish tank 38. This allows for quick and easy draining of the main fish tank 38.

FIG. 5 shows a complete wire-frame view of one embodiment of the aquarium water changing and stabilization system from a perspective to the left and slightly above the front of the aquarium. FIG. 5's numbered items point out the components of the aquarium cabinet. The cabinet may be made primarily of a wood product, although other materials are envisioned. All shelves and wall sections of the cabinet are coupled together for support.

On the front of the cabinet and coupled into the bottom of the upper cabinet shelf, such as with dowels, (FIG. 4, 43), is a panel 51. Also, below the upper cabinet shelf (FIG. 4, 43), may be a left and right mid cabinet side panels 54, that and may be coupled into the upper cabinet shelf (FIG. 4, 43) and lower cabinet shelf (FIG. 4, 45), such as with dowels. Each of these left and right mid cabinet side panels 54, may have two cutouts. These cutouts may provide access to each side of the main fish tank cabinet area. Each of these mid cabinet side panel cutouts may be covered with cabinet doors 50, which may be relatively small, that use appropriately placed hidden European hinges and cabinet door handles, although other makes and models are anticipated. A swing up front access panel 53may be connected to the mid cabinet side panels 54, such as with metal pins 52, that allow this front access panel 53, to swing up and provide access to the front of the main fish tank. When this panel 53, is in the down position, it provides a pleasing aesthetic look to the front of the aquarium cabinet by blocking the view into the interior plumbing and open back of the aquarium.

In FIG. 5, at rear of the mid cabinet section is a left and right mid section “L” strut 62. Each of these struts 62 may consist of two pieces of wood product that are doweled and glued together at right angles for strength, although other materials, dimensions, methods of affixation and configurations are envisioned. The side of these struts may be attached to the interior wall of the mid cabinet side panels 54, such as with at least four appropriately placed #6 gauge wood screws.

The lower portion of the aquarium cabinet may be designed to allow room 64, for normal aquarium filtration system hardware and/or pump 36, in the case that pump 36 is not submersible. In addition, as illustrated herein, the lower portion of the aquarium cabinet may be designed to allow room 64 for water change tank 49. At rear of the lower cabinet section may be another set of left and right lower section “L” struts 60. Each of these struts 60 may consist of two pieces of wood product that are doweled and glued together at right angles for strength, although other materials, dimensions and means of affixation are envisioned. The side of these lower section “L” struts 60, may be coupled to the interior wall of the lower left and right side cabinet side panels 55. These lower cabinet side panels 55, may be doweled into the lower cabinet shelf (FIG. 4, 45) and the cabinet bottom 57. On all of the back-facing five inch wide piece of “L” struts in the mid and lower cabinet sections 62 & 60, that may be flush with the backend of the aquarium cabinet side panels and shelves, there may be bolt holes 61, that allow for bolts or self anchoring wood screws to be attached through the back of the aquarium cabinet to the building wall where the aquarium is located, although other dimensions, means of affixation and locations are envisioned. The “L” strut bolt holes may be located four inches from the top and bottom of the struts and be centered in the back-facing five inch wide piece of the “L” strut. These bolts ensure a secure and stable aquarium that will not tip over or sway when properly bolted to the building wall behind the aquarium cabinet. On the front side of the lower part of the aquarium cabinet may be two slot vented left and right lower cabinet filtration system access doors 56, although other numbers, dimensions and configurations are envisioned. There may be slots 65, that are located on each lower cabinet door. These front lower cabinet doors are attached to the cabinet by appropriately placed hidden European hinges, although other types of hinges may be used. Appropriately placed cabinet door handles may be on the all cabinet doors for easy opening. Between and behind the lower front cabinet doors 56, may be a center lower front cabinet door support and stop 58.

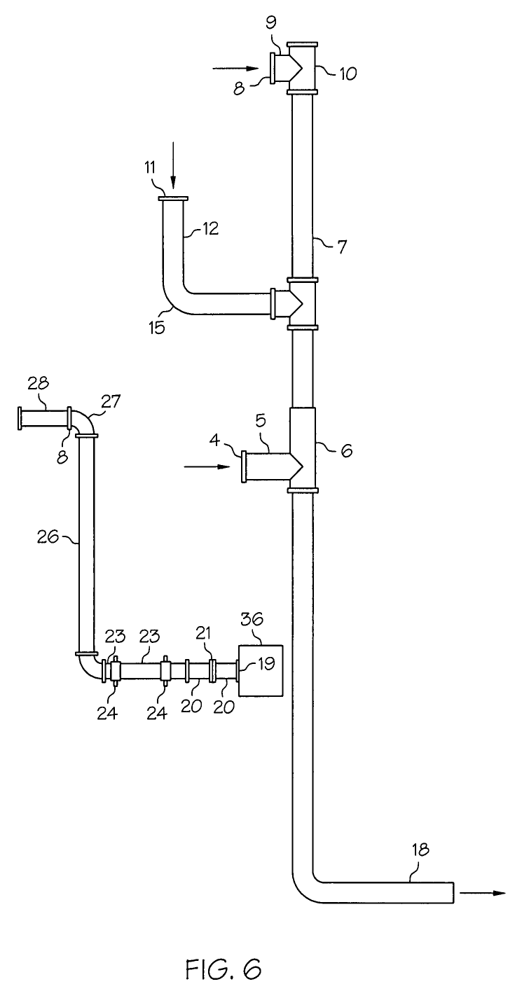

FIG. 6 is a sectional right side view of the aquarium plumbing only that allows conditioned and stabilized water from the water change tank (FIG. 4, 32) be pumped into the main fish tank (FIG. 4, 38). This section of plumbing starts with a bulkhead fitting 19, which may be ¾″ and double threaded, that may be inserted down into a plumbing access hole that may be located on the bottom of the water change tank (see FIG. 4). This bulkhead 19, is connected to one of two segments of vertical pipe 20, which may be ¾″ diameter and which may include a ¾″ check valve 21 in the middle. At the bottom of the lower pipe segment 20, is an elbow 22, that points towards the back of the aquarium at a substantially 90.degree. angle and is attached to substantially horizontal segments of pipe 23, which has an inline pump 36 and one or more ball valve sockets 24, in the middle. Attached to the end of the back portion of segments 23 and 24 is another elbow, that and points substantially 90.degree. upward and is attached to a substantially vertical segment that in one embodiment is ¾″ pipe 26. The top end of this vertical segment of pipe 26, is attached to an elbow 27, that points towards the front of the aquarium at a substantially 90.degree. angle and is attached to a substantially horizontal pipe 28, that in one embodiment is ¾″ diameter. At the front end of this substantially horizontal segment of pipe 28, is an elbow 29, that in one embodiment is ¾″ and points substantially downward at a 90.degree. angle and directs the water flowing out of this plumbing system onto a splash guard 30 or below the water line, to prevent splashing within the main fish tank when this plumbing is in use. The splash guard 30 if present, is attached to the back main fish tank wall below the elbow 29, although other configurations and sizes are envisioned. Further, although the description accompanying FIG. 6, indicates ¾″ pipes and valves, 1″ or any other size of pipe may be used. Furthermore, as indicated elsewhere herein, materials and configurations of the apparatus may vary.

What is claimed is:

1. A system for introducing fluids into an aquarium, comprising:
a container for containing fluids that are at least one of treated or introduced into the aquarium;
an input conduit for introducing the fluids into the container from an existing water feed;
a pump for conducting the fluids into the aquarium via a connecting conduit, the connecting conduit having a flow direction limiting apparatus for ensuring that the fluids do not flow into the container and a flow regulator for regulating a volume of flow of the fluids; and
a drainage conduit for draining fluids from the aquarium, the drainage conduit ensuring that the fluids in at least one of the aquarium or the container do not exceed a predetermined level,
wherein a flow of the fluids between the container and the aquarium is only from the container to the aquarium.

2. The system of claim 1, wherein the drainage conduit is connected to an existing external sewage line.

3. The system of claim 1, wherein the input conduit is a pipe.

4. The system of claim 1, wherein the connecting conduit is a pipe.

5. The system of claim 1, wherein the drainage conduit is a pipe.

6. The system of claim 1, wherein the container is an auxiliary aquarium.

7. The system of claim 1, further comprising a fluid treater for treating the fluids in the container.

8. A system for introducing fluids into an aquarium, comprising:
a container for containing the fluids that are at least one of treated or introduced into the aquarium;
means for introducing the fluids into the container from an existing water feed;
pumping means for conducting the fluids into the aquarium via a connecting conduit, the connecting conduit having a flow direction limiting apparatus for ensuring that the fluids do not flow into the container and a flow regulator for regulating a volume of flow of the fluids; and
means for draining fluids from the aquarium, the drainage conduit ensuring that the fluids in at least one of the aquarium or the container do not exceed a predetermined level,
wherein a flow of the fluids between the container and the aquarium is only from the container to the aquarium.

9. The system of claim 8, further comprising means for treating the fluids in the container.

10. A method for introducing fluids into an aquarium, comprising:
introducing the fluids into a container from an existing water feed;
treating the fluids to achieve a state that is similar to current fluids in the aquarium;
draining at least some of the current fluids from the aquarium to ensure that the fluids in at least one of the aquarium or the container do not exceed a predetermined level, and
pumping the fluids into the aquarium via a connecting conduit while ensuring that the fluids do not flow into the container and regulating a volume of flow of the fluids;
wherein a flow of the fluids between the container and the aquarium is only from the container to the aquarium.

11. The method of claim 10, wherein the introducing is done via a pipe.

12. The method of claim 10, wherein the conducting is done via a pipe.

13. The method of claim 10, wherein the draining is done via drainage conduit which is a pipe.

14. The method of claim 13, wherein the drainage conduit is connected to an existing external sewage line.

15. The method of claim 10, wherein the container is an auxiliary aquarium.
